(19) United States
(12) Patent Application Publication
(10) Pub. No.: US 2019/0015975 A1
(43) Pub. Date: Jan. 17, 2019

(54) Robotic positioning system

(71) Applicant: Peak Analysis and Automation Limited, Farnborough Hampshire (GB)

(72) Inventors: Rob HARKNESS, Farnborough Hampshire (GB); Dewang SHARMA, Farnborough Hampshire (GB)

(21) Appl. No.: 16/034,583

(22) Filed: Jul. 13, 2018

(30) Foreign Application Priority Data
Jul. 14, 2017 (GB) 1711355.6

(51) Int. Cl. B25J 9/16; G05B 19/18; G05B 19/402

(52) U.S. Cl. CPC B25J 9/161; B25J 9/1612; G05B 19/402; G05B 19/188; B25J 9/1664

(57) ABSTRACT

A microplate handling apparatus comprising: a housing; a robotic arm mounted to the housing; and a controller located within the housing and arranged to control the robotic arm and further arranged to control an instrument. By embedding the controller within the robotic arm rather than having it as a separate PC the controller becomes a dedicated controller for the robotic arm and any associated instruments. As the controller is a dedicated controller, users are less likely to attempt to make use of the controller for any other purpose. The system provider/installer retains much greater control of the set up, e.g. of the operating system and software installation. There is a much lower likelihood of conflicting software or erroneous settings causing software problems. This reduces the number of software support problems that need to be answered which in turn reduces the cost of the system itself and/or any associated support contract. This benefit is particularly relevant to smaller, bench top systems where the operational scale (lab scale) is generally smaller and project budgets are also smaller. Thus the equipment and support cost is of much greater importance in such systems.

The invention relates to robotic arms and positioning systems, particularly in desktop laboratory automation environments such as for moving and handling ANSI/SLAS-1 microplates.

In such systems, microplates (typically 96 well, 384 well or 1536 well plates) are processed by a machine (there are many different such machines, each performing different sample preparation or analysis activities). A machine can typically only operate on a single microplate at a time, but it is desirable to process a large number of microplates in sequence. In order to save laboratory technician time, automation systems are designed with a robotic arm to move microplates between different processing stations, e.g. between microplate storage devices and one or more processing machines. By storing a large number of microplates in the storage device(s), a robotic arm can load and remove the microplates from the machine as required without supervision, thus allowing long processing runs to take place without technician input.

During such long processing runs, both the robotic arm and the processing machines (instruments) need to be operated and coordinated. For example the machine needs to know when a new plate has been deposited by the robotic arm, ready for processing. Equally, the robotic arm needs to know when the machine has finished its work and the plate can be removed. This could all be achieved without any kind of external coordination, e.g. using time windows with ample margins for error. However, the margins for error would need to be significant to avoid mis-handling of plates such as attempting to deposit or remove a plate while the instrument is still operating which could lead to errors which can halt a whole processing run, causing major losses of time and efficiency, or which can cause spillage of hazardous substances resulting in time-consuming clean-up operations. However using large time margins to avoid such incidents severely reduces the time (and therefore cost) efficiency of the whole operation. Therefore it is normal for both the robotic arm and the instrument to be controlled by a separate computer. This is typically a standard desktop PC loaded with proprietary software for controlling both the arm and the instrument. As the PC has control over both devices it can control the timings of pick-up and place operations and it can control the instrument operation commands accurately, thus minimising delays and making the optimum use of the time available, while minimising potential errors.

However, there are some problems with this arrangement. One problem is that the majority of software support requests that are made to the suppliers of robotic arm and instrument suppliers are not a result of faulty or malfunctioning software, but are a result of the PC setup, e.g. operating system problems or clashes with other software. Providing this support is a significant cost that has to be factored into the cost to supply the hardware and any associated software support contract. Another problem that arises in smaller lab-scale or bench top systems is that the PC takes up space and needs to be accommodated around the robotic arm and instruments, usually with cables to connect each device. Bench space can be limited and there can also be restraints due to the limitations of movement of the robotic arm (e.g. its reach or its degrees of freedom). The PC is also a constraint to moving (e.g. relocating) the set-up.

According to the invention there is provided a microplate handling apparatus comprising: a housing; a robotic arm mounted to the housing; and a controller located within the housing and arranged to control the robotic arm and further arranged to control an instrument.

By embedding the controller within the robotic arm rather than having it as a separate PC the controller becomes a dedicated controller for the robotic arm and any associated instruments. As the controller is a dedicated controller, users are less likely to attempt to make use of the controller for any other purpose. The system provider/installer retains much greater control of the set up, e.g. of the operating system and software installation. There is a much lower likelihood of conflicting software or erroneous settings causing software problems. This in turn greatly reduces the number of software support problems that need to be answered which in turn reduces the cost of the system itself and/or any associated support contract. This benefit is particularly relevant to smaller, bench top systems where the operational scale (lab scale) is generally smaller and project budgets are also smaller. Thus the equipment and support cost is of much greater importance in such systems.

The controller is preferably arranged to control the robotic arm and the instrument by generating commands and issuing those to the robot and instrument (these commands typically being issued by the software running on the controller). The apparatus may essentially be considered as a robotic arm with an embedded controller that is capable of controlling not only the movements of the robotic arm, but also the operation of the (or each) instrument which is being served by the robotic arm. Thus the system has the benefits of a single controller that can efficiently operate all associated machines for optimum time usage (and thus optimum throughput of microplates) while reducing the support issues and thus further improving efficiency. Additionally, as the controller is embedded within the robotic arm there is reduced space usage on the bench as there is no need to make room for a separate controller such as a desktop PC.

The addition of the embedded controller increases the cost of the system as robotic arms were not previously supplied with any such processing capabilities. The provision of the embedded controller does also make it more difficult (and costly) to effect a hardware upgrade as this may now require return of the equipment to the supplier or attendance of a robotics engineer on site. However, this invention has recognised that these additional costs are more than offset by the reduced cost of supplying support services and that this arrangement actually provides improvements in terms of cost and reliability compared with the traditional arrangement, despite the increased hardware cost.

The housing preferably comprises an output communication port and the controller is preferably arranged to send control signals for an instrument via the output communication port. In existing systems the robotic arm and its housing may be designed to have a receiving port to receive commands, but would not be arranged to output commands. However, according to the invention, as the controller is embedded within the housing, an output port is preferably provided for connection to the or each instrument that is to be controlled by the controller. In other embodiments control may be effected via wireless communication. In such embodiments the controller is preferably arranged to send control signals (e.g. to the required instruments) by a suitable wireless protocol such as over WiFi, Bluetooth, Zigbee, etc. In many cases, wired ports will still be preferred for reliability and for avoidance of interference. In such cases, any suitable ports may be used, e.g. ethernet or serial ports. A typical example might be USB ports or SICA (Small Interface Cable Adapter) ports.

The controller preferably comprises a scheduler which is programmable to control both the instrument and the robotic arm. The scheduler may be software that is preloaded onto the controller and is adapted to issue generic commands understood by all or most associated instruments. However, for greatest flexibility and to allow control of non-standard instruments or new instruments with previously unsupported features, the controller software may be updated so as to add functionality for the instruments which need to be controlled. For example, software plug-ins or modules may be added as required and updated when necessary.

Any suitable interface may be used for setting up the system and programming the controller software (e.g. scheduler). However, for convenience, the controller is preferably arranged to provide a webserver interface for programming software loaded onto the controller. A webserver interface is readily accessible by most user devices and this allows the controller to be accessed and programmed by connecting to it via another computer (e.g. desktop or laptop PC, tablet, PDA, smartphone, etc.). The webserver interface may for example be used to effect software updates, install the required plug-ins or modules and to set up the scheduler so as to issue appropriate commands at the appropriate times and in an appropriate order to the robotic arm and the attached instruments.

As discussed above, this invention finds particular applicability in smaller systems. In particular, the microplate handling apparatus is preferably a bench top apparatus.

Such systems are typically lower cost and thus the cost advantages of this arrangement provide the greatest relative benefit.

The invention also extends to a system comprising a microplate-handling instrument and a microplate handling apparatus as described above (optionally including any of the preferred or optional features also discussed above).

It will be appreciated that any types of instrument may be controlled with this system, but in preferred embodiments the instruments are microplate handling apparatuses of various sorts. For example, microplate processing instruments, microplate analysis instruments, plate stacking or storing instruments, etc. As above, the microplate-handling instrument is preferably a bench top instrument. The (or each) microplate-handling instrument may be controlled by the controller.

Plate stacking/storage devices may include one or more vertical stacks of microplates. In simple stack arrangements the robotic arm may simply retrieve a microplate from the top of a stack and/or deposit a microplate on top of a stack (e.g. retrieving sequentially from an input stack and depositing sequentially on an output stack). In other stack arrangements the robotic arm may select a microplate from one of several vertical positions within the stack (and can deposit back to any of those vertical positions). In more complex storage devices, the storage device may have internal mechanisms for selecting from the stack and may simply offer a selected microplate up to the robotic arm at a single well-defined position. The latter type of stack can preferably be controlled by the embedded controller in the robotic arm in a similar manner to other instruments, e.g. so that the embedded controller can issue commands for a certain plate to be made available or for a plate just deposited to be stored in a particular location.

Preferred embodiments of the invention will now be described, by way of example only, and with reference to the accompanying drawings in which:

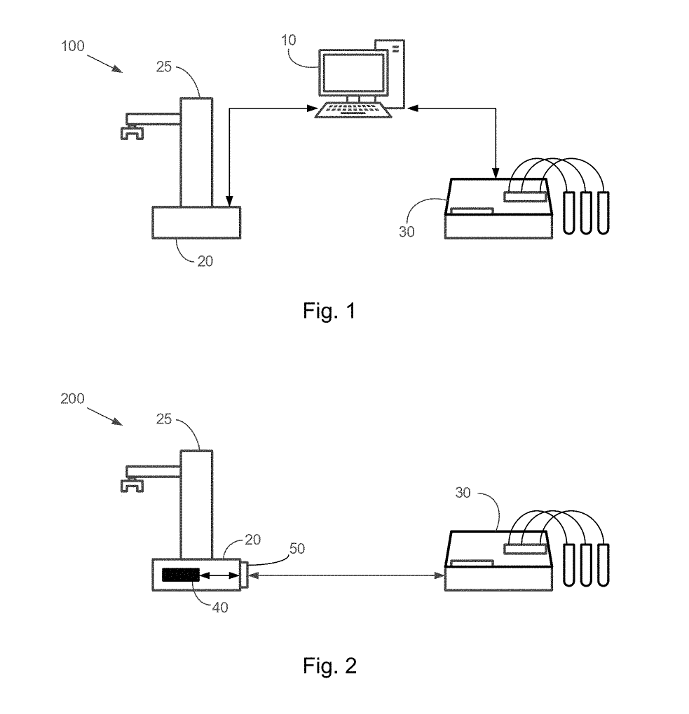

FIG. 1 shows a prior art bench top microplate handling system;

FIG. 2 shows a microplate handling system according to the invention.

FIG. 1 shows a known bench top microplate handling apparatus 100. A robotic arm 25 is mounted to a housing 20. The robotic arm 25 may be of any suitable type, but for example may have a central vertical rotary shaft which can rotate around a central axis (this being the primary axis of rotation for the robotic arm 25). A rigid bar may extend horizontally from the central shaft and be vertically movable relative to the shaft, i.e. vertically movable parallel to the rotation axis. The robotic arm 25 has a number of degrees of freedom which allow it to pick up and deposit microplates within its work envelope (the locus of positions reachable by the arm). Thus by positioning plate storage devices such as plate stacks or plate nests and/or plate processing equipment such as microplate processing or analysis machines 30 within the work envelope, the robotic arm can be used to automate the transfer of microplates from the storage devices to the processing equipment and to return the plates from the processing equipment to the same or different storage devices. The robotic arm may also handle the removing and replacing of microplate lids if required.

As shown in FIG. 1, both the robotic arm 25 and a microplate analysis machine 30 are separately controlled by a desktop PC 10. The PC is a standard desktop computer running an operating system such as Microsoft Windows®, MacOS® or Linux®. The PC 10 runs a scheduler program which may be proprietary software that generates and issues commands for each of the robotic arm 25 and the analysis machine 30. The robotic arm 25 and the analysis machine 30 can be operationally connected to the PC 10 by wires or cables such as ethernet cables, USB cables or other serial cable connections. Alternatively wireless protocols such as Bluetooth may be used to send and receive control signals. The scheduler software on the PC 10 controls the timing and interleaving of such commands for efficient and reliable operation of the system 100 as a whole. For example, the scheduler software may issue the following sequence of instructions:
Instruct the robotic arm 25 to fetch a microplate from an input plate stack (not shown) and deposit it on a temporary plate storage nest (first nest).
Instruct the robotic arm 25 to remove a lid from the microplate and store the lid on another nest.
Instruct the robotic arm 25 to fetch the microplate from the first nest and deposit it on an analysis machine 30.
Instruct the analysis machine 30 to begin processing the microplate.
Wait for a completion signal from the analysis machine 30.
Instruct the robotic arm 25 to fetch the processed microplate from the analysis machine 30 and deposit it on the first nest.
Instruct the robotic arm 25 to fetch the lid from the second nest and replace it on the processed microplate.
Instruct the robotic arm 25 to fetch the processed microplate (with lid) and deposit it on an output plate stack.

This series of instructions may be repeated until all plates have been processed. It will be appreciated that significantly more complex processing can be performed, e.g. to make more efficient use of the analysis machine 30 or to encompass additional processing machines 30.

FIG. 2 shows an embodiment of the invention in which a microplate handling apparatus 200 has no separate PC 10, but instead has an embedded controller 40 embedded within the robotic arm 25 (specifically within the housing 20 to which the robotic arm is attached). The embedded controller 40 can perform all the same functions as the PC 10 and may in fact be a fully functional miniature computer such as a Raspberry Pi or other versatile controller such as an Arduino®. However, because the controller 40 is embedded in the robotic arm 25 rather than being a separate desktop PC, it is not easily usable for other general tasks or loading other software (as is the case for the desktop PC 10 in FIG. 1). This reduces the possibility for errors in set up and errors due to software conflict, thus greatly reducing the potential for support calls and thereby greatly reducing the support costs for the system 200. Additionally the absence of the desktop PC 10 reduces the desk top footprint of the system 200 as no PC 10 is required.

The embedded controller 40 can run the same (or very similar) scheduler program to control both the robotic arm 25 and one or more attached peripheral devices such as analysis machine 30. As the controller 40 is embedded, it can be provided with pre-wired connections to the robotic arm 25 for control thereof. The controller 40 is connected to an output port 50 on the housing 20 for connection of a wire or cable to the analysis machine 30 (there may of course be a plurality of such output ports 50 for connection to several machines, or such machines may be networked or daisy-chained via a single port 50). The port may of course also be an input port (i.e. a two-way port) so that the attached equipment 30 can provide status updates or feedback to the controller 40 (such as an “analysis complete” signal or the like). In alternative examples, instead of (or in addition to) wired connections, wireless communication protocols may be used to communicate with the attached equipment 30.

The embedded controller 40 is not as readily accessible as a stand-alone PC. For example, the robotic arm 25 and housing 20 will not normally have an integrated keyboard or pointer device and therefore access to the controller 40 will need to be accomplished either by attaching such peripherals or by remote connecting to the controller 40. For example, the controller 40 may be arranged to receive remote login connections such as via SSH. An alternative is to have the controller 40 running a webserver and allowing programming of the controller 40 and more specifically the scheduler software (or similar) through a web interface. This web interface again provides a restricted access to the users so that the controller 40 is only used for control of the robotic arm 25 and the equipment 30 and cannot readily be used for other purposes that may conflict or interfere with that operation.

It will be appreciated that the controller 40 may otherwise provide the full functionality that was previously available via a stand-alone desktop PC 10, including allowing for software updates (e.g. updating to a new version of the operating system or of the scheduler software) and allowing fetching and installation of add-ons or modules to allow for control of multiple different pieces of equipment and to allow for expansion to new equipment as and when available.

1. A microplate handling apparatus comprising:
a housing;
a robotic arm mounted to the housing; and
a controller located within the housing and arranged to control the robotic arm and further arranged to control an instrument.

2. A microplate handling apparatus as claimed in claim 1, wherein the housing comprises an output communication port and wherein the controller is arranged to send control signals for an instrument via the output communication port.

3. A microplate handling apparatus as claimed in claim 1, wherein the controller comprises a scheduler which is programmable to control both the instrument and the robotic arm.

4. A microplate handling apparatus as claimed in claim 1, wherein the controller is arranged to provide a webserver interface for programming software loaded onto the controller.

5. A microplate handling apparatus as claimed in claim 1, wherein the apparatus is a bench top apparatus.

6. A system comprising a microplate-handling instrument and a microplate handling apparatus as claimed in claim 1.

7. A system as claimed in claim 6, wherein the microplate-handling instrument is a bench top instrument.

8. A system as claimed in claim 6, wherein the microplate-handling instrument is controlled by the controller.
